(19) United States
(12) Patent Application Publication
(10) Pub. No.: US 2024/0372845 A1
(43) Pub. Date: Nov. 7, 2024

(54) IMAGE PROCESSING APPARATUS AND AUTHENTICATION PROCESSING METHOD

(71) Applicant: SHARP KABUSHIKI KAISHA, Osaka (JP)

(72) Inventor: Shingo TOKUNAGA, Osaka (JP)

(21) Appl. No.: 18/640,424

(22) Filed: Apr. 19, 2024

(30) Foreign Application Priority Data
May 2, 2023 (JP) 2023-076194

(51) Int. Cl. H04L 9/40

(52) U.S. Cl. CPC H04L 63/08; H04L 63/108

(57) ABSTRACT

Provided is an image processing apparatus including a storage and one or more controllers. The storage stores an account for a service providing device. The one or more controllers control authentication processing for the service providing device based on the account. Upon receiving input of a new account, the one or more controllers store the new account in the storage as a second account if the one or more controllers determine that the new account is compatible with the same authentication method as a first account stored in the storage. The second account is an alternative account to the first account.

### BACKGROUND OF THE INVENTION

### Field of the Invention

The present disclosure relates to an image processing apparatus and the like.

### Description of the Background Art

Recently, OAuth authentication methods, which are more secure than conventional authentication methods where user IDs and passwords are used, are becoming mainstream authentication methods for e-mail transmission.

Tokens that are used for OAuth authentication have an expiration period to ensure security. If a token has expired, reauthentication processing is required, which involves acquiring authorization from an administrator who is an account owner, and e-mails cannot be sent during the reauthentication processing.

For example, a known mechanism prompts reauthentication processing for OAuth authentication in a case where a token has expired.

An object of the present disclosure is to provide an image processing apparatus and the like that makes it possible to avoid a situation where e-mails cannot be sent until reauthentication processing is executed for an account due to expiration of a token for the account.

### SUMMARY OF THE INVENTION

In order to solve the problem described above, the present disclosure provides an image processing apparatus including: a storage that stores an account for a service providing device; and one or more controllers that control authentication processing for the service providing device based on the account, wherein upon receiving input of a new account, the one or more controllers store the new account in the storage as a second account if the one or more controllers determine that the new account is compatible with the same authentication method as a first account stored in the storage, the second account being an alternative account to the first account.

The present disclosure also provides an authentication processing method including: storing, in a storage, an account for a service providing device as a first account; storing, upon receiving input of a new account, the new account in the storage as a second account if the new account is determined to be compatible with the same authentication method as the first account, the second account being an alternative account to the first account; and executing authentication processing for the service providing device based on any of the accounts stored in the storage.

According to the present disclosure, it is possible to provide an image processing apparatus and the like that makes it possible to avoid a situation where e-mails cannot be sent until reauthentication processing is executed for an account due to expiration of a token for the account.

### BRIEF DESCRIPTION OF THE DRAWINGS

FIG. 1 is a diagram illustrating a form of connection between a multifunction peripheral, a cloud, and an e-mail delivery server.

FIG. 2 is a functional configuration diagram of the multifunction peripheral.

FIG. 3 is a diagram for describing an account management table.

FIG. 4 is a flowchart for describing a flow of processing according to a first embodiment.

FIG. 5 is a sequence diagram for describing a flow of commands according to the first embodiment.

FIG. 6 is a sequence diagram for describing a flow of commands according to the first embodiment.

FIG. 7 is a flowchart for describing a flow of processing according to the first embodiment.

FIG. 8 is a diagram illustrating an operation example according to the first embodiment.

FIG. 9 is a diagram illustrating an operation example according to the first embodiment.

FIG. 10 is a diagram illustrating an operation example according to the first embodiment.

FIG. 11 is a flowchart for describing a flow of processing according to a second embodiment.

FIG. 12 is a diagram illustrating an operation example according to the second embodiment.

FIG. 13 is a diagram illustrating an operation example according to the second embodiment.

FIG. 14 is a flowchart for describing a flow of processing according to a third embodiment.

FIG. 15 is a diagram illustrating an operation example according to the third embodiment.

FIG. 16 is a diagram illustrating an operation example according to the third embodiment.

FIG. 17 is a diagram illustrating an operation example according to the third embodiment.

FIG. 18 is a flowchart for describing a flow of processing according to a fourth embodiment.

FIG. 19 is a diagram for describing an account management table.

### DESCRIPTION OF THE PREFERRED EMBODIMENTS

The following describes embodiments of the present disclosure with reference to the accompanying drawings. It should be noted that the embodiments below are presented as examples for describing the present disclosure, and the technical scope of the description as recited in the appended claims is not limited by the following description.

When a user sends an e-mail from an image processing apparatus, authentication processing for an e-mail delivery service, an authentication service, or other service is performed using an account that has been set up in advance by, for example, an administrator of the image processing apparatus. If this account is compatible with an OAuth authentication method, and a token for the account has expired, the account needs to go through reauthentication processing by the administrator even though the administrator performed authentication processing when setting up the account.

Typically, the reauthentication processing is performed by the owner of the account (administrator), and therefore other users cannot send e-mails until the reauthentication processing is completed. In particular, if an e-mail transmission failure occurs when the user is not operating an operation screen of the image processing apparatus, such as when an incoming fax is automatically forwarded, the job may continue to fail for a long period of time without the user noticing the e-mail transmission failure.

Furthermore, in some cases of OAuth authentication, the number of tokens that can be acquired for each account is limited. In a case where an account is used across a large number of devices, and the number of tokens acquired reaches a limit, an e-mail transmission failure is more likely to occur.

Through the following embodiments, the present disclosure allows for implementation of an image processing apparatus and the like that makes it possible to avoid a situation where e-mails cannot be sent until reauthentication processing is executed for an account due to expiration of a token for the account.

### 1. First Embodiment

### 1.1. Overall Configuration

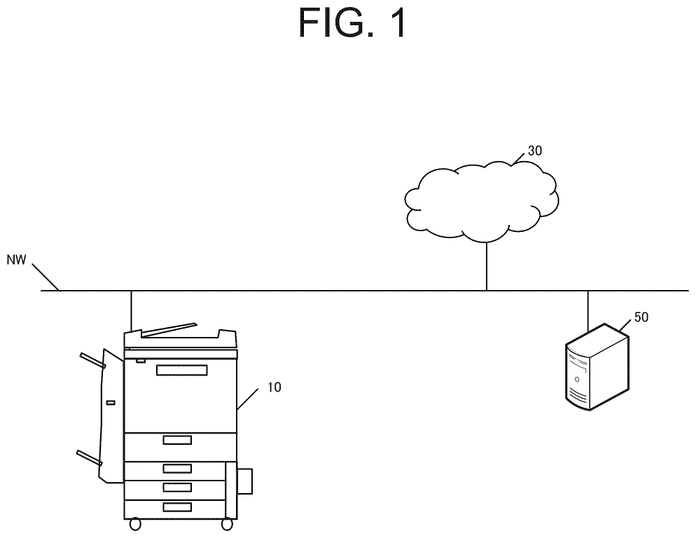

FIG. 1 is a diagram illustrating an example of a form of connection between a multifunction peripheral 10, which is an image processing apparatus according to a first embodiment, a cloud 30, which is a service providing device, and an e-mail delivery server 50.

The multifunction peripheral 10 according to the first embodiment is an image processing apparatus capable of performing printing, copying, faxing (Internet fax), e-mail transmission, and the like, in a single housing. The following describes the multifunction peripheral 10 as a form of an image processing apparatus according to the first embodiment. However, the present disclosure is not particularly limited as such and is applicable to any image processing apparatus, such as a copier, a printer, or a fax machine, as long as the image processing apparatus has a configuration that allows for authentication processing using an account compatible with OAuth authentication.

The multifunction peripheral 10 is connected to the cloud 30 and the e-mail delivery server 50 via a network NW. The multifunction peripheral 10 is, for example, configured to communicate with the cloud 30 and the e-mail delivery server 50 based on a communication protocol such as Internet Protocol (IP), Transmission Control Protocol (TCP), Hypertext Transfer Protocol (HTTP), or Simple Mail Transfer Protocol (SMTP). It should be noted that the network NW represents a network line such as a local area network (LAN), a wide area network (WAN), or the Internet. The number of multifunction peripherals 10 connectable to the network NW is not limited to that in the example shown in FIG. 1, and a plurality of multifunction peripherals 10 may be connected to the network NW.

The cloud 30 includes, for example, an authorization server (not shown) that performs resource access authorization by implementing an authorization code flow based on an OAuth 2.0 authentication method. No particular limitations are placed on the device configuration of the cloud 30 as long as the cloud 30 is configured to generate an authorization code, an access token, which is authorization information, a refresh token, which is refresh request information, in response to authentication (authorization). For example, the cloud 30 may include an authorization server that processes the authorization code flow and a resource server that provides resources as separate devices, or may include a single device that has both an authentication function and a resource provision function.

The e-mail delivery server 50 performs e-mail delivery in accordance with SMTP and Post Office Protocol (POP). The e-mail delivery server 50 is capable of transmitting an e-mail to a specific destination and delivering a received e-mail in response to an e-mail transmission request from the cloud 30 (resource server) via an application programming interface (API). It should be noted that the e-mail delivery server 50 may be configured as a resource server in the cloud 30.

### 1.2. Functional Configuration

### 1.2.1. Multifunction Peripheral 10

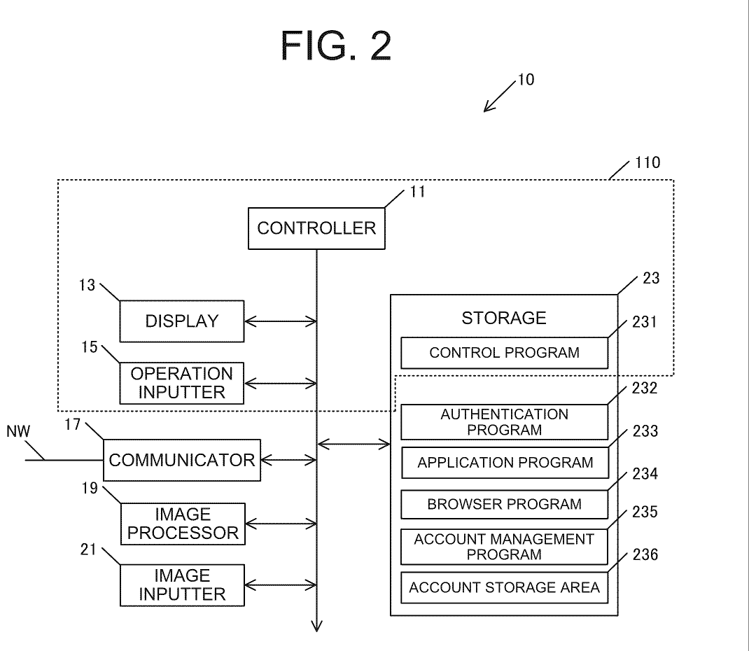

Next, the following describes a functional configuration of the multifunction peripheral 10 according to the first embodiment with reference to FIG. 2. The multifunction peripheral 10 includes a controller 11, a display 13, an operation inputter 15, a communicator 17, an image processor 19, an image inputter 21, and a storage 23.

The controller 11 performs overall control of the multifunction peripheral 10. The controller 11 includes, for example, one or more arithmetic devices (such as central processing units (CPUs)). The controller 11 reads and executes various programs stored in the storage 23, and thus implements functions thereof.

The display 13 displays various types of information to a user, for example. The display 13 may include, for example, a liquid crystal display (LCD) or an organic electro-luminescence (EL) display. The display 13 displays, based on the control by the controller 11, a screen based on screen information for viewing generated by a browser program 234 described below.

The operation inputter 15 receives input of information by, for example, a user. The operation inputter 15 may include, for example, operation keys, such as hardware keys or software keys, and various input devices, such as buttons. It should be noted that the operation inputter 15 can be configured as a touch panel that allows input through the display 13. In this case, the operation inputter 15 can function as a user interface (UI) through a Web browser screen or an application screen displayed on the display 13. The touch panel may adopt, for example, a common input method such as a resistive method, an infrared method, an inductive method, or a capacitive method.

The controller 11 functions as an operating system (OS) by reading a control program 231 described below. A UI that is driven based on control by such an OS may be referred to as an UI/OS 110 in the first embodiment.

The communicator 17 includes, for example, either or both of a wired interface and a wireless interface to communicate with other devices (the cloud 30 and the e-mail delivery server 50) via the network (NW) such as a LAN, a WAN, the Internet, a telephone line, or a facsimile line. Furthermore, the communicator 17 may include, for example, an interface related to a (short-range) wireless communication technique such as Bluetooth (registered trademark), near field communication (NFC), Wi-Fi (registered trademark), ZigBee (registered trademark), Irda, or wireless USB.

The image processor 19 includes an image former that forms an image based on image data on, for example, paper, which is a recording medium. The image former feeds paper from a paper feed tray, not shown, forms an image on the paper based on image data, and then discharges the paper to a paper discharger, not shown. The image former may include, for example, an electrophotographic laser printer. In this case, the image former forms images using toners supplied from toner cartridges, not shown, corresponding to respective toner colors (for example, cyan, magenta, yellow, and black). The image processor 19 may generate output image data to be attached to an e-mail by performing, for example, shading correction or density correction on image data inputted from the image inputter 21.

The image inputter 21 generates image data by scanning a document. The image inputter 21 may be, for example, configured as a scanner device that includes an image sensor such as a charge coupled device (CCD) or a contact image sensor (CIS) and has an automatic document feeder (ADF), a flatbed, on which the document is placed and read, and the like. No particular limitations are placed on the configuration of the image inputter 21 as long as the image inputter 21 is configured to generate image data by reading a reflected light image from a document image using an image sensor. It should be noted that the image inputter 21 can be, for example, configured as an interface that allows for acquisition of image data stored in a portable storage medium such as universal serial bus (USB) memory or image data sent from an external terminal device, not shown.

The storage 23 stores therein various programs necessary for operation of the multifunction peripheral 10 and various types of data. The storage 23 may include, for example, storage devices such as random access memory (RAM), a hard disk drive (HDD), a solid state drive (SSD), and read only memory (ROM).

In the first embodiment, the storage 23 stores therein the control program 231, an authentication program 232, an application program 233, the browser program 234, and an account management program 235. In the storage 23, an account storage area 236 is reserved.

The controller 11 reads the control program 231 when comprehensively controlling the multifunction peripheral 10. The controller 11 that has read the control program 231 functions as an OS and controls the driving of the display 13, the operation inputter 15, the communicator 17, the image processor 19, and the image inputter 21 to set, execute, and post-process jobs such as printing, copying, faxing, and e-mail transmission jobs.

The controller 11 reads the authentication program 232 when executing authentication processing between the multifunction peripheral 10 and the cloud 30. The controller 11 that has read the authentication program 232 executes the authentication processing for the cloud 30 via a web browser described below. It should be noted that the controller 11 that has read the authentication program 232 can also perform, for example, conventional authentication processing (for example, SMTP authentication processing and POP authentication processing) using a combination of a user name (user ID) and a password, and authentication of login to the multifunction peripheral 10, in addition to authentication by a method that requires prior authorization, such as OAuth authentication. The controller 11 that has read the authentication program 232 also verifies, as authentication processing, whether or not the access token can be refreshed based on the refresh token (referred to below as refresh validity). The access token is authorization information for using the e-mail delivery service provided by the cloud 30 (e-mail delivery server 50) serving as a service providing device. The refresh token is refresh request information associated with the account. The controller 11 of the present disclosure verifies the refresh validity of the access token based on the expiration period set for the refresh token.

The controller 11 reads the application program 233 to implement functions such as printing, copying, faxing, and e-mail transmission functions. The application program 233 may be an integrated management application that is responsible for setting, management, and the like of the multifunction peripheral 10, or may be an individual application (for example, a scan transmission application) that uses the integrated management application as a platform. The controller 11 that has read the application program 233 can use a function implemented through another program such as the authentication program 232 via an API. The application program 233 and the authentication program 232 can work together to perform acquisition, refresh, exchange, or the like of authentication information and access tokens between the multifunction peripheral 10 and the cloud 30. The present embodiment is described using an example in which the application program 233 and the authentication program 232 are separate programs. However, the function of the authentication program 232 may be incorporated in the application program 233. In the following description, the form of the controller 11 reading the application program 233, and thus operating for the user's purpose will be referred to simply as an application.

The controller 11 reads the browser program 234 when generating screen information for viewing by rendering inputted content. The controller 11 that has read the browser program 234 functions as a Web browser and can receive input and a request from the user or display a notification from the application to the user through a Web browser screen displayed.

The controller 11 reads the account management program 235 when managing accounts set up for providers. The controller 11 that has read the account management program 235 determines, upon receiving input of a new account through, for example, a setting screen, not shown, whether or not the authentication method of the new account is compatible with the OAuth authentication method. Upon determining that the authentication method of the new account is compatible with the OAuth authentication method, the controller 11 stores the new account as a second account, which is an alternative account to a first account already stored in the account storage area 236. Upon determining that the authentication method of the new account is not compatible with the OAuth authentication method, the controller 11 stores the new account in the account storage area 236 as an account employing a different authentication method.

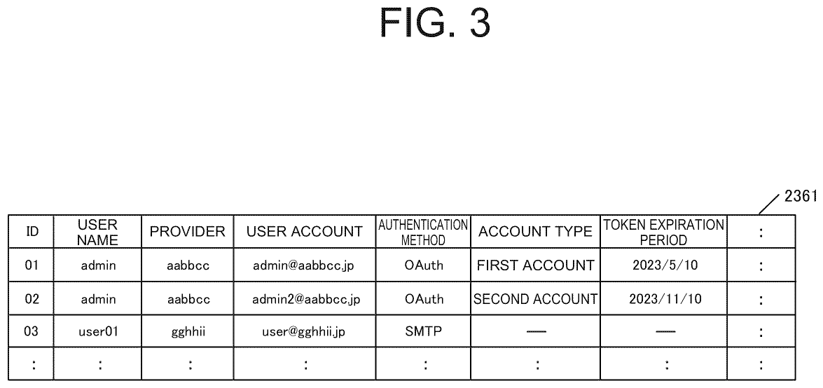

The account storage area 236 is reserved to store accounts. Accounts are stored in the account storage area 236 in the form of an account management table 2361 shown as an example in FIG. 3 based on the control by the controller 11 that has read the account management program 235. The account storage area 236 may be, for example, provided in an external storage device connected to the network NW other than the multifunction peripheral 10.

The following now describes a configuration example of the account management table according to the first embodiment with reference to FIG. 3. The configuration of the account management table shown in FIG. 3 is merely an example, and the account management according to the present disclosure is not limited to the example shown in FIG. 3. For example, the account management table may include items other than examples of management items shown in FIG. 3. Furthermore, the accounts are not limited to being managed in the tabular form and may alternatively be managed in a database form.

The account management table 2361 includes ID, user name, provider, user account, authentication method, account type, and token expiration period as management items.

The “ID” refers to an identifier for uniquely identifying each account that is managed. The “user name” refers to a name of the owner of each account. The “provider” refers to a name of each authentication point (cloud 30). The “user account” refers to a name of each account that is used for the authentication processing. The “authentication method” refers to an authentication method employed by each account. The “account type” refers to the type of each account that is compatible with the OAuth authentication method. The “token expiration period” refers to an expiration period of a token issued by the cloud 30 for each account. The term token according to the present disclosure as used herein means a refresh token (refresh request information) for refreshing an access token (authorization information) for accessing to resources on the cloud 30 (e-mail delivery server 50). The term expiration period according to the present disclosure means a certain duration for which a token issued by the cloud 30 is valid, and may be expressed as a date and time or as a period of time from a date of issue by the cloud 30 to a specific date. In addition to these management items, the account management table 2361 may include, for example, password, token (individual token), authorization code, and contact information (for example, an e-mail address) of the account owner associated with each user account.

For example, the account associated with an ID “01” is owned by a user having a user name “admin”. The authentication point of the account associated with the ID “01” is a provider “aabbcc”, and a user account “admin@aabbcc.jp” is used for such authentication. The account associated with the ID “01” is compatible with the OAuth authentication method (authentication method “OAuth authentication method”), and the type of this account is “first account”. A first account refers to an account that is already stored in the account storage area 236 and is used as a main account in the authentication processing related to e-mail transmission. The expiration period of the token for the account associated with the ID “01” is “2023 May 10”. After the token has expired, the authentication processing with the use of this account will fail.

The account associated with an ID “02” is owned by the user having the user name “admin”. The authentication point of the account associated with the ID “02” is the provider “aabbcc”, and a user account “admin2@aabbcc.jp” is used for such authentication. The account associated with the ID “02” is compatible with the OAuth authentication method (authentication method “OAuth authentication method”), and the type of this account is “second account”. A second account refers to an account that is received as a new account and is stored in the account storage area 236 as an alternative account to a first account already stored in the account storage area 236 if the controller 11 determines that the authentication method of the new account is compatible with the OAuth authentication method. When the expiration period “May 10, 2023” of the token for the first account has passed, the controller 11 executes authentication processing using the second account, which is an alternative account to the first account. Authentication processing using an account according to the present disclosure refers to a concept that encompasses authentication and authorization processing in accordance with the OAuth authentication method. Examples thereof include authentication processing for the cloud 30 using, for example, a user account (account name) and a password, authorization processing using an access token, and authentication and authorization processing such as token refresh request processing on an access token based on a refresh token.

The account associated with an ID “03” is owned by a user having a user name “user01”. The authentication point of the account associated with the ID “03” is a provider “gghhii”, and a user account “user@gghhii.jp” is used for such authentication. The account associated with the ID “03” is not compatible with the OAuth authentication method (authentication method “SMTP authentication method”). This account does not belong to any of the account types “first account” and “second account” (account type: “−”).

### 1.2.2. Cloud 30

The cloud 30 according to the first embodiment may adopt any known configuration as long as the configuration includes an authorization server that authorizes access to resources by implementing an authorization code flow based on the OAuth authentication method. Description of the functional configuration of the cloud 30 is therefore omitted.

### 1.2.3. E-mail Delivery Server 50

The e-mail delivery server 50 according to the first embodiment may adopt any known configuration as long as the configuration allows for transmission of an e-mail to a specific destination or delivery of a received e-mail in response to an e-mail transmission request from the cloud 30 (resource server) via an API. Description of the functional configuration of the e-mail delivery server 50 is therefore omitted.

### 1.3. Flow of Processing

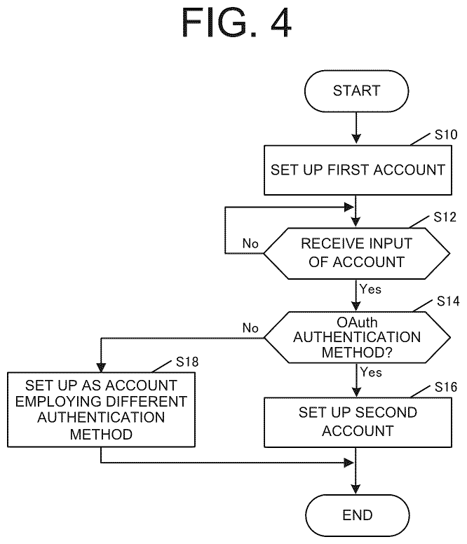

Next, the following describes a flow of processing according to the first embodiment. FIG. 4 is a flowchart for describing processing for setting up (storing) a received new account as a second account if the authentication method of the received new account is compatible with the OAuth authentication method. The processing described with reference to the flowchart shown in FIG. 4 is executed through the controller 11 reading a program such as the account management program 235. In FIG. 4, the description starts with a process for setting up (storing) an account compatible with the OAuth authentication method as a first account.

First, the controller 11 receives setting of an account compatible with the OAuth authentication method from an administrator of the multifunction peripheral 10 (for example, the account owner indicated by the user name “admin” associated with the ID “01” shown as an example in the account management table 2361 in FIG. 3). The controller 11 sets up the received account as a first account related to authentication processing for e-mail transmission. After receiving setting of the first account, the controller 11 stores this account in the account management table 2361 (Step S10).

Next, the controller 11 determines whether or not input of a new account has been received (Step S12). Upon determining that input of a new account has been received, the controller 11 determines whether or not the authentication method of the new account is compatible with the OAuth authentication method (Yes in Step S12→Step S14). Upon determining that input of a new account has not been received, the controller 11 waits until input of a new account is received (No in Step S12).

Upon determining that the authentication method of the new account is compatible with the OAuth authentication method, the controller 11 sets up the new account as a second account, which is an alternative account to the first account, and ends the processing (Yes in Step S14→Step S16). In this case, the controller 11 executes authentication processing for the cloud 30 using the second account.

Upon determining that the authentication method of the received account is not compatible with the OAuth authentication method, the controller 11 sets up the received account as an account employing a different authentication method and ends the processing (No in Step S14→Step S18).

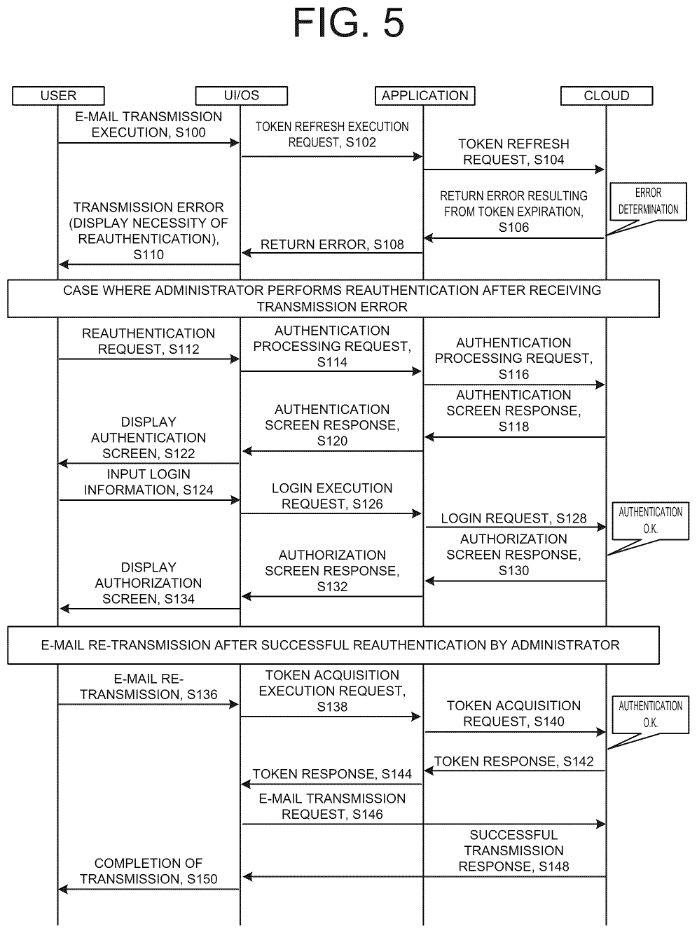

Next, with reference to FIG. 5, the following describes a command sequence between the user (administrator), the UI/OS 110, the application, and the cloud 30 in a case where a transmission error occurs due to token expiration and reauthentication is performed by the user (administrator). It should be noted that the following mainly describes token refresh request processing as the authentication processing.

First, upon the user inputting an e-mail transmission execution instruction (S100), the UI/OS 110 sends a token refresh execution request command to the application (S102).

The application sends a token refresh request command to the cloud 30 (S104). Upon receiving the token refresh request command, the cloud 30 checks the expiration period of the refresh-requested token for validity. If the token has already expired, the cloud 30 determines the e-mail transmission to be an error (error determination). The cloud 30 then returns the error resulting from token expiration to the application (S106). If the token has not expired, a refreshed token (access token or refresh token) is issued and a token response command is sent to the application. Upon receiving the token response command, the application passes the token to the UI/OS 110. The UI/OS 110 sends an e-mail transmission request command including the acquired token to the cloud 30 (resource server). The cloud 30 (resource server) checks the validity of the received token and requests the e-mail delivery server 50 for the e-mail transmission. If the e-mail transmission is successful, the cloud 30 (resource server) sends a successful transmission response command to the UI/OS 110. The UI/OS 110 notifies the user of the completion of the e-mail transmission.

Upon receiving the error returned from the cloud 30, the application returns the error to the UI/OS 110 (S108). The UI/OS 110 notifies the user of the transmission error and the fact that authentication is required (necessity of reauthentication) due to the transmission error (S110).

Next, the following describes a case where the administrator as a user performs reauthentication after receiving the transmission error.

The UI/OS 110 receives a reauthentication request instruction from the administrator (S112). Upon receiving the reauthentication request instruction, the UI/OS 110 sends an authentication processing request command to the application (S114). Upon receiving the authentication processing request command, the application sends an authentication processing request command to the cloud 30 (S116).

Upon receiving the authentication processing request command, the cloud 30 sends an authentication screen response command to the application (S118). The authentication screen response command may include content pertaining to an authentication screen for receiving input of authentication information (login information) from the administrator and a uniform resource locator (URL) indicating a storage location of the content.

Upon receiving the authentication screen response command, the application sends an authentication screen response command to the UI/OS 110 (S120). The command that is sent from the application to the UI/OS 110 may include an instruction for displaying the authentication screen via a web browser, in addition to the content pertaining to the authentication screen and the location information such as a URL received from the cloud 30.

Upon receiving the authentication screen response command from the application, the UI/OS 110 displays the authentication screen to the administrator (S122).

The UI/OS 110 receives input of login information from the administrator (S124). Upon receiving input of the login information, the UI/OS 110 sends a login execution request command to the application (S126). Upon receiving the login execution request command from the UI/OS 110, the application sends a login request command to the cloud 30 (S128).

The cloud 30 performs login authentication by checking the validity of the received login information. If the login authentication is successful (authentication O.K.), the cloud 30 sends an authorization screen response command to the application (S130). The authorization screen response command may include content pertaining to an authorization screen for receiving input on whether or not resources can be used and a URL indicating a storage location of the content.

Upon receiving the authorization screen response command, the application sends an authorization screen response command to the UI/OS 110 (S132). The command that is sent from the application to the UI/OS 110 may include an instruction for displaying the authorization screen via a web browser, in addition to the content pertaining to the authorization screen and the location information such as a URL received from the cloud 30.

Upon receiving the authorization screen response command from the application, the UI/OS 110 displays the authorization screen to the administrator (S134).

Next, the following describes e-mail re-transmission after successful reauthentication by the administrator.

The UI/OS 110 receives input of an e-mail re-transmission instruction from the administrator (S136). Upon receiving input of the e-mail re-transmission instruction, the UI/OS 110 sends a token acquisition execution request command to the application (S138). Upon receiving the token acquisition execution request command from the UI/OS 110, the application sends a token acquisition request command including an authorization code to the cloud 30 (S140).

The cloud 30 issues a token based on the authorization code (authentication O.K.) and sends a token response command to the application (S142). Upon receiving the token response command, the application passes the token to the UI/OS 110 (S144).

The UI/OS 110 sends an e-mail transmission request command including the acquired token to the cloud 30 (resource server) (S146). The cloud 30 (resource server) checks the validity of the received token and requests the e-mail delivery server 50 for the e-mail transmission. If the e-mail transmission is successful, the cloud 30 (resource server) sends a successful transmission response command to the UI/OS 110 (S148). The UI/OS 110 notifies the user of the completion of the e-mail transmission (S150).

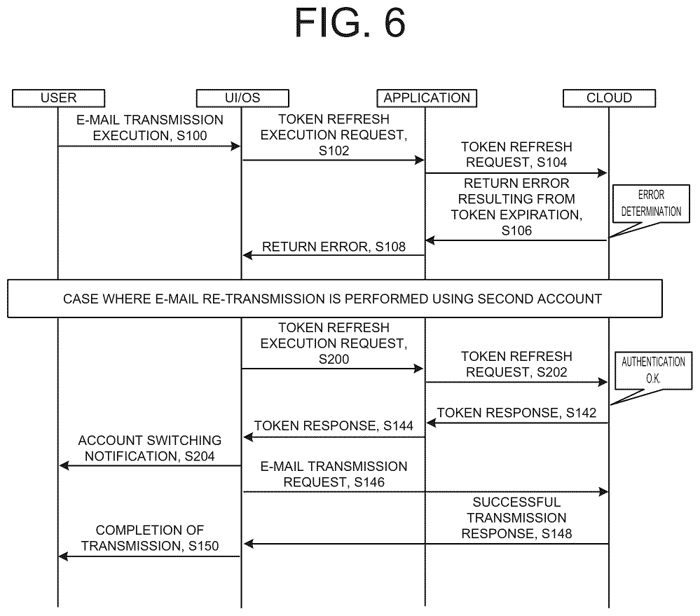

Next, with reference to FIG. 6, the following describes a command sequence between the user, the UI/OS 110, the application, and the cloud 30 in a case where a transmission error occurs due to token expiration and e-mail re-transmission is performed using a second account. It should be noted that S100 to S108 and S142 to S150 in this command sequence are the same as those described with reference to FIG. 5, and thus description thereof is omitted herein.

Upon receiving the error returned from the application, the UI/OS 110 switches the user's account to the second account and sends a token refresh execution request command to the application (S200). The application sends a token refresh request command to the cloud 30 (S202). Upon receiving the token refresh request command, the cloud 30 checks the expiration period of the refresh-requested token for validity. If the token for the second account has not expired, the cloud 30 determines that the authentication is successful (authentication O.K.). The cloud 30 then issues a token and sends a token response command to the application (S142). Upon receiving the token response command, the application passes the token to the UI/OS 110 (S144). If the token for the second account has already expired, the cloud 30 determines the e-mail transmission to be an error (error determination). The cloud 30 then returns the error resulting from token expiration to the application. Upon receiving the error returned from the cloud 30, the application returns the error to the UI/OS 110. The UIOS 110 notifies the user of the transmission error and the fact that authentication is required (necessity of reauthentication) due to the transmission error.

The UI/OS 110 notifies the user that the user's account has been switched (S204). The UI/OS 110 also sends an e-mail transmission request command together with the acquired token to the cloud 30 (resource server) (S146). The cloud 30 (resource server) checks the validity of the received token and requests the e-mail delivery server 50 for the e-mail transmission. If the e-mail transmission is successful, the cloud 30 (resource server) sends a successful transmission response command to the UI/OS 110 (S148).

The UI/OS 110 notifies the user of the completion of the e-mail transmission (S150).

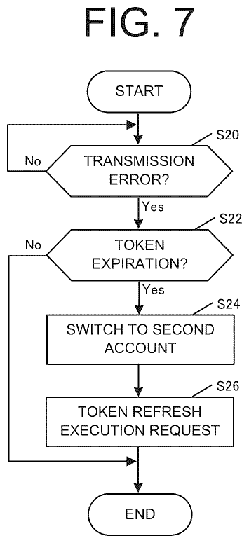

FIG. 7 is a flowchart for describing processing to be executed by the UI/OS 110 upon receiving the error returned from the application in S108 in FIG. 6.

The UI/OS 110 determines whether or not a transmission error has been returned from the application (Step S20). Upon determining that a transmission error has been returned from the application, the UI/OS 110 analyzes the content of the received transmission error and determines whether or not the transmission error is resulting from token expiration (Yes in Step S20→Step S22). Upon determining that no transmission error has been returned from the application, the UI/OS 110 waits until a transmission error is returned from the application (No in Step S20).

Upon determining, as a result of the analysis of the transmission error, that the transmission error is resulting from token expiration, the UI/OS 110 switches the user's account to the second account (Yes in Step S22→Step S24). Upon determining that the transmission error is not resulting from token expiration, the UI/OS 110 determines that the transmission error is resulting from a simple account authentication failure, for example, and ends the processing without switching the user's account to the second account (No in Step S22→“End”).

After switching the user's account to the second account, the UI/OS 110 sends a token refresh execution request command to the application and ends the processing (Step S26).

If the user's account is switched to the second account in all cases where a transmission error occurs, e-mail transmission will be executed even in cases where e-mail transmission is undesirable from a security standpoint, such as where authentication of the account fails. According to the first embodiment, therefore, the user's account is switched to the second account based on certain conditions, such as token expiration. This configuration makes it possible to prevent undesired e-mail transmission in cases where a transmission error occurs and e-mail transmission is undesirable from a security standpoint.

### 1.4. Operation Example

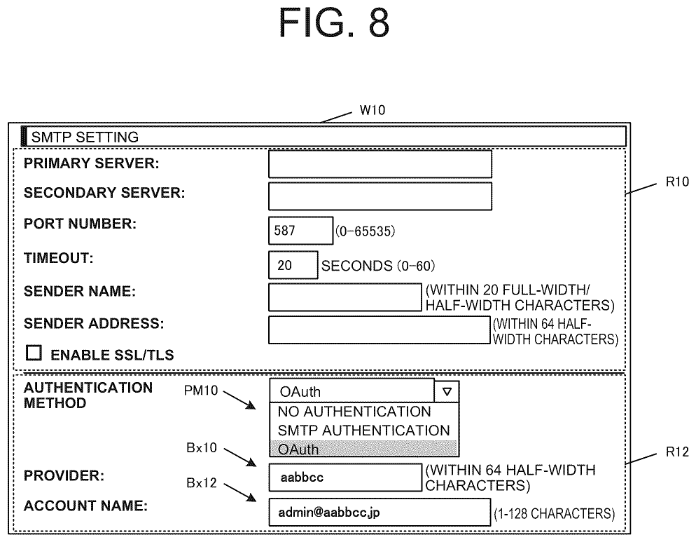

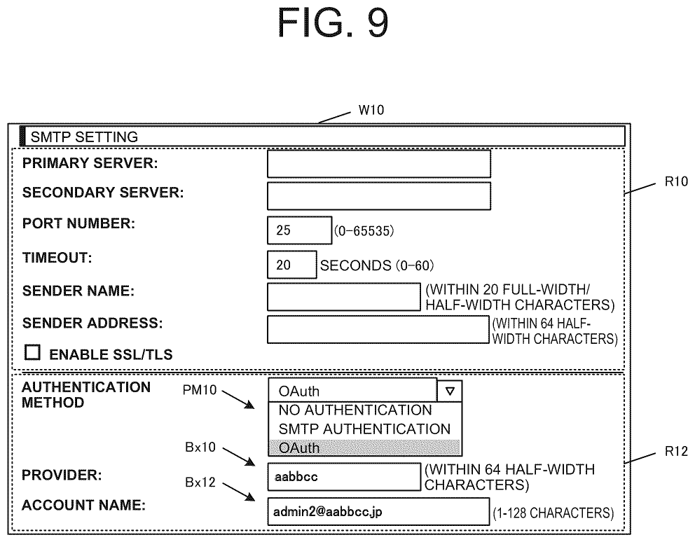

Next, the following describes an operation example according to the first embodiment. FIGS. 8 and 9 are diagrams illustrating a configuration example of an SMTP setting screen W10. FIG. 8 is a diagram illustrating an operation for setting up a first account, and FIG. 9 is a diagram illustrating an operation for setting up a second account. The operation example described with reference to FIGS. 8 and 9 corresponds to the processing shown as an example in FIG. 4.

The SMTP setting screen W10 shown as an example in FIGS. 8 and 9 includes an SMTP setting area R10 and an authentication method setting area R12.

The SMTP setting area R10 includes, as setting items, primary server, secondary server, port number, timeout, sender name, sender address, and a check box for enabling SSL/TLS.

A primary server entry box and a secondary server entry box are used for specifying the e-mail delivery server 50, and receive input of information such as the name (domain name) and the IP address of the e-mail delivery server 50. The secondary server entry box may be left blank if it is not necessary to configure settings therein.

A port number entry box receives input of a port number of the e-mail delivery server 50. A timeout entry box receives input of the length of a duration for which an idle state is maintained before a connection timeout is triggered. A sender name entry box receives input of a name of a sender of an e-mail, and a sender address entry box receives input of an e-mail address of the sender of the e-mail. The check box for enabling SSL/TLS receives specification of whether or not to encrypt data in a case where the data is transmitted and received over the Internet.

The authentication method setting area R12 includes an authentication method selection pull-down menu PM10, a provider entry box Bx10, and an account name entry box Bx12.

The authentication method selection pull-down menu PM10 receives selection of an authentication method. FIGS. 8 and 9 show a configuration in which one of the following authentication methods is selectable: “no authentication”, “SMTP authentication”, and “OAuth authentication”. FIGS. 8 and 9 show an example in which the OAuth authentication method has been selected as the authentication method.

The provider entry box Bx10 receives input of a name of a provider (cloud 30) to be an authentication point. FIGS. 8 and 9 show an example in which “aabbcc” has been inputted as the provider.

The account name entry box Bx12 receives input of a name of an account for the authentication point provider. FIG. 8 shows an example in which input of “admin@aabbcc.jp” has been received as a name of an account that is a first account. FIG. 9 shows an example in which input of “admin2@aabbcc.jp” has been received as a name of an account that is a second account.

The settings inputted through the SMTP setting screen W10 shown as an example in FIGS. 8 and 9 are stored in the account management table 2361 shown as an example in FIG. 3.

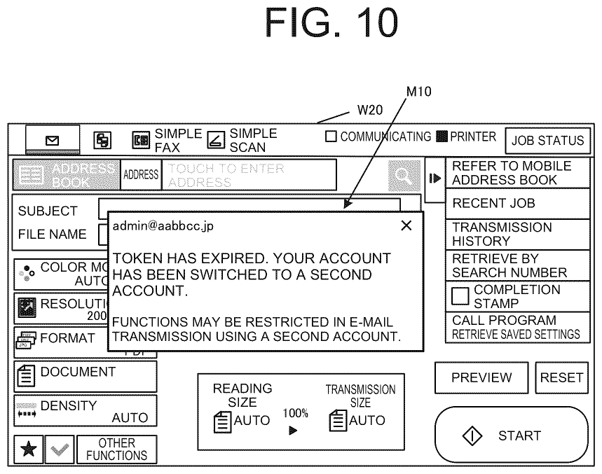

FIG. 10 is a diagram for describing a display configuration example of an account switching notification screen. FIG. 10 shows an example in which a message screen M10 is superimposed on a job execution screen W20 of the scan transmission application.

The message screen M10 is an example of a message screen that contains the following as a notification to indicate that a token associated with the account name “admin@aabbcc.jp” (first account) has expired and the user's account has been switched to a second account: “Token has expired. Your account has been switched to a second account.” In a case where any restriction is placed on scan transmission (e-mail transmission) using a second account (for example, where switching to a second account is restricted to when the token has expired, or where e-mail transmission using a second account is restricted to when a reauthentication request is sent to the account owner (administrator) (second embodiment)), the following message, for example, may be added to draw the user's attention: “Functions may be restricted in e-mail transmission using a second account.”

According to the first embodiment, as described above, e-mail transmission is executed even in a case where a token for a first account has expired, by switching the user's account to a second account, which is an alternative account to the first account. It is therefore possible to avoid a situation where e-mails cannot be sent until reauthentication processing is executed for the first account due to expiration of the token for the first account. According to the first embodiment, furthermore, it is possible to prevent undesired use of the second account for e-mail transmission such as scan transmission, and place restriction on e-mail transmission to a destination that is undesirable from a security standpoint.

### 2. Second Embodiment

According to a second embodiment, after the user's account has been switched from a first account to a second account, a notification prompting reauthentication is sent to the account owner of the first account based on the second account.

### 2.1. Functional Configuration

Functional configurations of a multifunction peripheral, a cloud, and an e-mail delivery server according to the second embodiment may be the same as the functional configurations of the multifunction peripheral 10, the cloud 30, and the e-mail delivery server 50 according to the first embodiment. Description thereof is therefore omitted herein.

### 2.2. Flow of Processing

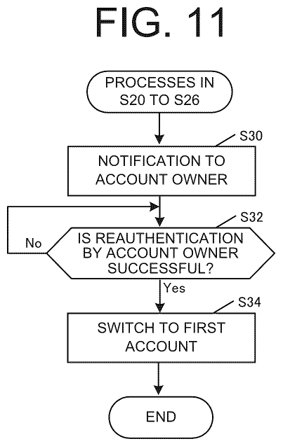

FIG. 11 is a flowchart for describing a flow of processing according to the second embodiment.

The following describes the processing shown in FIG. 11 as a continuation of the processing described with reference to Steps S20 to S26 shown in FIG. 7.

The UI/OS 110 makes a notification prompting the account owner to execute reauthentication processing with respect to the first account (Step S30).

Next, the UI/OS 110 determines whether or not the reauthentication processing has been executed by the account owner and the reauthentication is successful (Step S32). Upon determining that the reauthentication is successful, the UI/OS 110 switches the user's account for the e-mail transmission from the second account to the first account and ends the processing (Yes in Step S32→Step S34). Upon determining that reauthentication is not successful, the UI/OS 110 waits until the reauthentication is successfully executed (No in Step).

### 2.3. Operation Example

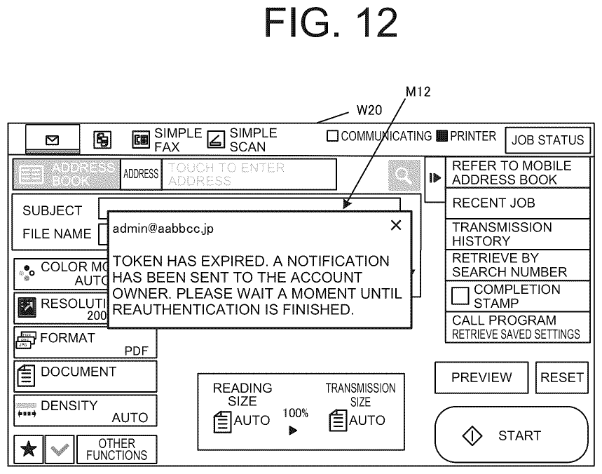

FIG. 12 is a diagram for describing a display configuration example of a notification screen that contains a message informing that a notification prompting reauthentication has been sent to the account owner. FIG. 12 shows an example in which a message screen M12 is superimposed on the job execution screen W20 of the scan transmission application.

The message screen M12 is an example of a message screen that contains the following as a notification prompting reauthentication with respect to the account named “admin@aabbcc.jp” (first account) due to expiration of the token for this account: “Token has expired. A notification has been sent to the account owner. Please wait a moment until reauthentication is finished.”

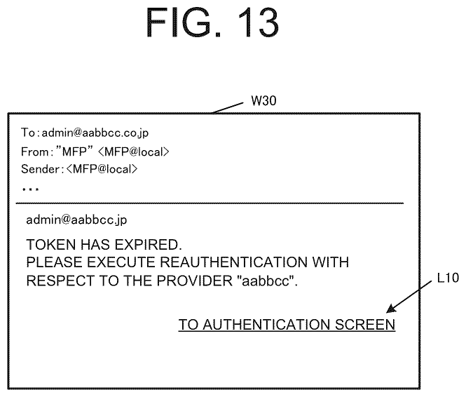

FIG. 13 is a diagram illustrating a configuration example of an e-mail transmission screen W30 for notifying the account owner (administrator) that the token associated with the account name “admin@aabbcc.jp” (first account) has expired and prompting reauthentication with respect to the account. FIG. 13 shows an example of an e-mail transmission screen that contains the following as a notification: “Token has expired. Please execute reauthentication with respect to the provider “aabbcc”.” The e-mail transmission screen W30 may include a link L10 to an authentication screen to facilitate the reauthentication processing by the account owner.

According to the second embodiment, as described above, after the user's account has been switched from a first account to a second account, a notification prompting reauthentication can be sent to the account owner of the first account based on the second account, so that the account owner of the first account can easily recognize that reauthentication is required with respect to the first account. Furthermore, according to the second embodiment, the user's account to be used for e-mail transmission can be switched to the first account if the reauthentication with respect to the first account is successfully executed after the e-mail transmission based on the second account. This configuration produces an effect of eliminating the need for the user to manually switch the user's account after successfully executing the reauthentication with respect to the first account.

### 3. Third Embodiment

The e-mail transmission based on the second account described in the first and second embodiments, which is performed when reauthentication is required because the token for the first account has expired, can fail to result in a transmission error in a case where the token for the second account has already expired. In order to avoid such a situation, according to a third embodiment, setting of an account as a second account is restricted if the provider selected for the account desired to be set up as a second account is the same as the provider associated with the already set first account to allow for a reduction in the possibility of failures in token acquisition for both the first account and the second account due to, for example, server down or token reset.

### 3.1. Functional Configuration

Functional configurations of a multifunction peripheral, a cloud, and an e-mail delivery server according to the third embodiment may be the same as the functional configurations of the multifunction peripheral 10, the cloud 30, and the e-mail delivery server 50 according to the first embodiment. Description thereof is therefore omitted herein.

### 3.2. Flow of Processing

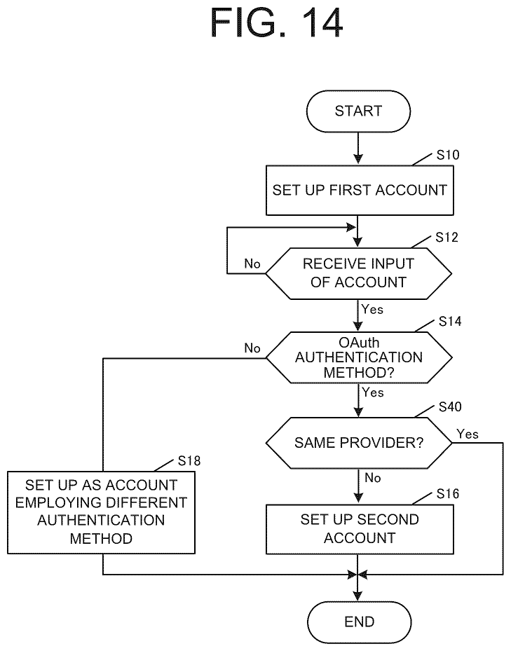

The flow of processing according to the third embodiment is represented by a flowchart shown in FIG. 14, which replaces the flowchart shown in FIG. 4. The same processes as in the first embodiment are therefore labeled with the same reference signs as in the first embodiment, and description thereof is omitted.

Upon determining that the authentication method of the received account is compatible with the OAuth authentication method, the controller 11 determines whether or not the provider selected for the received account is the same as the provider associated with the first account (Step S40). Upon determining that the provider selected for the received account is the same as the provider associated with the first account, the controller 11 ends the processing without setting up the received account as a second account (Yes in Step S40→“End”). In this case, the controller 11 may make a notification prompting the user to set up the account by selecting a different provider than the provider associated with the first account.

Upon determining that the provider selected for the received account is not the same as the provider associated with the first account, the controller 11 sets up the received account as a second account and ends the processing (No in Step S40→Step S16→“End”).

### 3.3. Operation Example

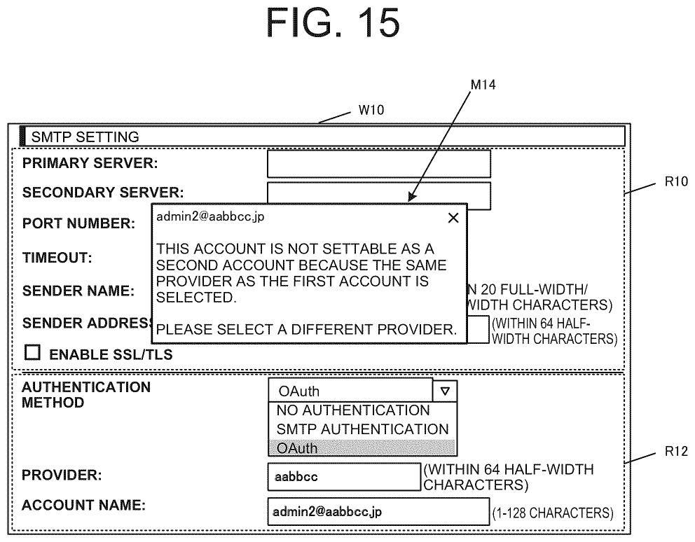

FIG. 15 shows an example in which a message screen M14 displaying the fact that the received account is not settable as a second account is superimposed on the SMTP setting screen W10.

The message screen M14 is an example of a message screen that contains the following as a notification to inform that the provider selected for the account (account name “admin2@aabbcc.jp”, provider name “aabbcc”) desired to be set up as a second account is the same as the provider (name) “aabbcc” associated with the first account, and the account is not settable as a second account: “This account is not settable as a second account because the same provider as the first account is selected. Please select a different provider.” In this case, the administrator can set up the account he/she inputted as a second account by selecting a provider other than the provider “aabbcc” associated with the first account.

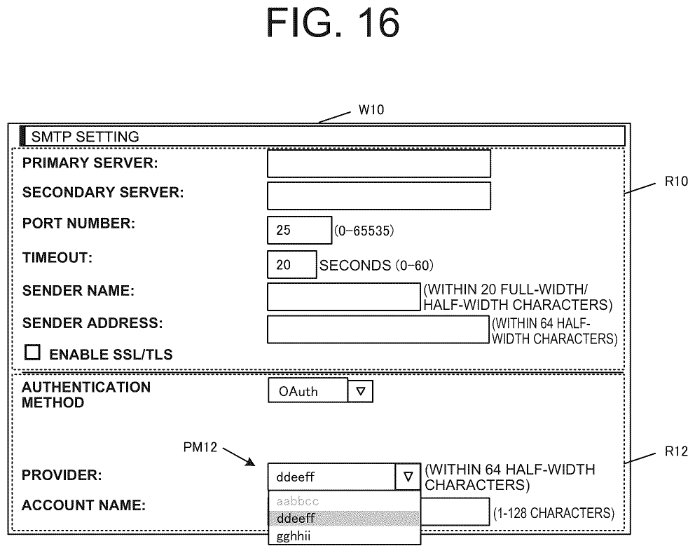

FIG. 16 is a diagram illustrating an example in which the selection of the same provider as the first account is restricted for an account to be set up as a second account. In the example shown in FIG. 16, the provider associated with the first account (provider name “aabbcc”) is grayed out in a pull-down menu PM12 that receives selection of a provider, thereby restricting the selection of this particular provider. As described above, the controller 11 may perform the control to disable selection of a provider associated with a first account for an account to be set up as a second account.

According to the third embodiment, as described above, setting of an account as a second account is restricted in such a manner as to prevent selection of a provider associated with an already set first account for an account desired to be set up as a second account, making it possible to reduce the possibility of failures in token acquisition for both the first account and the second account due to, for example, server down or token reset, which are possible if the provider associated with the second account is the same as the provider associated with the first account.

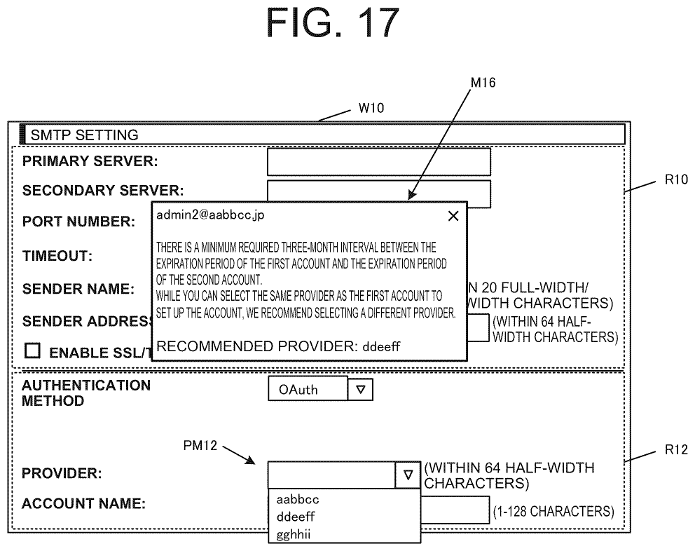

It should be noted that the controller 11 may accept the selection of the provider associated with the first account for an account to be set up as a second account if, for example, the account is set up as a second account at a point in time that ensures a predetermined interval (for example, three months) between the expiration period of the first account and the expiration period of the second account. In this case, as shown as an example in a message screen M16 in FIG. 17, it is desirable to display a message screen that contains the following, for example, to draw the user's attention by prompting the user to select a different provider than the provider associated with the first account for the account to be set up as a second account: “There is a minimum required three-month interval between the expiration period of the first account and the expiration period of the second account. While you can select the same provider as the first account to set up the account, we recommend selecting a different provider. Recommended provider: ddeeff”.

It should be noted that the provider determination processing for accounts described above may be performed at the cloud 30. In this case, the cloud 30 can either refuse authentication with respect to the second account or send a notification prompting a change to a different provider to the controller 11 of the multifunction peripheral 10 if the cloud 30 determines that the provider associated with the second account is the same as the provider associated with the first account in the course of the authentication processing with respect to the second account.

### 4. Fourth Embodiment

According to a fourth embodiment, it is possible to check the expiration period of a token for a first account and the expiration period of a token for a second account, and to prompt reauthentication at an appropriate date and time so that the tokens for these accounts do not expire at the same time.

### 4.1. Functional Configuration

Functional configurations of a multifunction peripheral, a cloud, and an e-mail delivery server according to the fourth embodiment may be the same as the functional configurations of the multifunction peripheral 10, the cloud 30, and the e-mail delivery server 50 according to the first embodiment. Description thereof is therefore omitted herein.

### 4.2. Flow of Processing

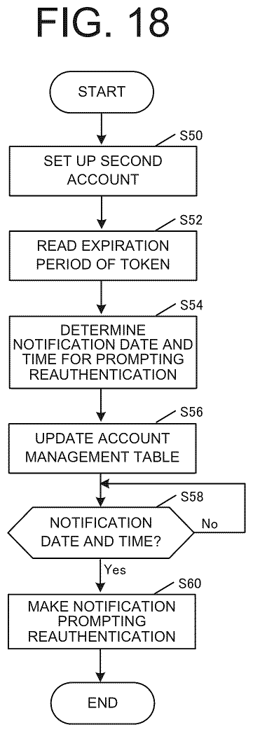

FIG. 18 is a flowchart for describing a flow of processing according to the fourth embodiment. The processing described with reference to the flowchart shown in FIG. 14 is executed through the controller 11 reading a program such as the account management program 235.

The controller 11 sets up an account as a second account, and then reads the expiration period of the token for the second account and the expiration period of the token for the first account from the account management table 2361 (Step S50→Step S52).

The controller 11 then determines a notification date and time for prompting reauthentication based on the expiration periods of the tokens read in Step S52 (Step S54).

Alternatively, the controller 11 may read the expiration period of the token for the first account before setting up the second account, and control the timing for setting up the second account so as to ensure that there is at least a predetermined interval between the expiration period of the token for the first account and the expiration period of the token for the second account.

The controller 11 updates the account management table by reflecting the notification date and time determined in Step S54 in the account management table 2361 (Step S56).

The controller 11 determines whether or not a date and time measured by a timer, not shown, has reached the notification date and time for prompting reauthentication (Step S58). Upon determining that the date and time measured by the timer has reached the notification date and time for prompting reauthentication, the controller 11 makes a notification prompting reauthentication to, for example, the account owner (administrator) and ends the processing (Yes in Step S58→Step S60). Upon determining that the date and time measured by the timer has not reached the notification date and time for prompting reauthentication, the controller 11 continues the measurement of the date and time using the timer, not shown, until the notification date and time is reached (No in Step S58).

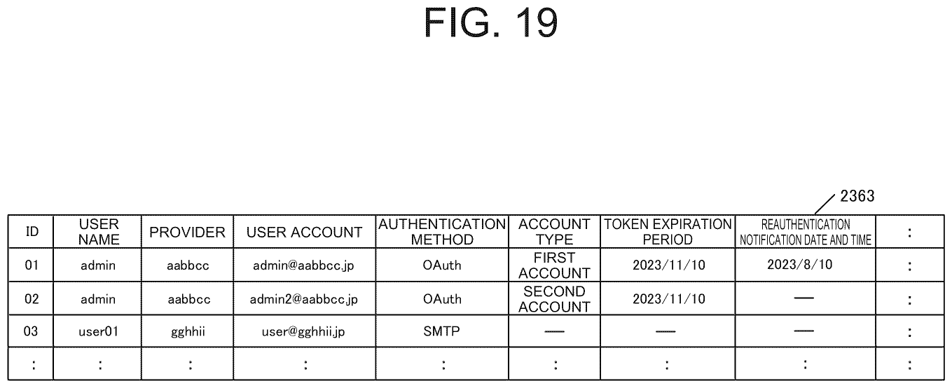

Now, with reference to FIG. 19, the following describes an account management table 2363 updated in the update process in Step S56 in FIG. 18. The account management table 2363 shown as an example in FIG. 19 includes reauthentication notification date and time as a management item in addition to the management items that are managed using the account management table 2361 shown as an example in FIG. 3. For example, both the issue date of the token for the account associated with the ID “01” and the issue date of the token for the account associated with the ID “02” are “May 10, 2023”, and the expiration periods of the tokens are “Nov. 10, 2023” (the tokens are valid for six months from the issue date thereof).

In a configuration in which the controller 11 does not determine the reauthentication notification date and time, and does not make a reauthorization notification, for example, the tokens for the two accounts associated with the ID “01” and the ID “02” expire on Nov. 10, 2023.

In a configuration such as shown in FIG. 19, however, the controller 11 sets the reauthentication notification date and time to, for example, a date and time (Aug. 10, 2023) that is three months from the token issue date (May 10, 2023) for one (token associated with the ID “01” in FIG. 19) of the tokens for the accounts associated with the ID “01” and the ID “02”, and makes a notification prompting reauthentication. This way, it is possible to prevent the tokens for the two accounts associated with the ID “01” and the ID “02” from expiring at the same time (on the same day). In the example shown in FIG. 19, the controller 11 sets the reauthentication notification date and time for the token for one of the accounts associated with the ID “01” and the ID “02”. However, it is needless to say that the controller 11 may set different reauthentication notification dates and times for the tokens for the two accounts associated with the ID “01” and the ID “02”.

According to the fourth embodiment, as described above, it is possible to prevent the token for the first account and the token for the second account from expiring at the same time by setting a reauthentication notification date and time for prompting reauthentication with respect to either or both of the tokens for the first account and the second account.

### 5. Modification Example

In some cases of OAuth authentication, the number of tokens that can be acquired for each account is limited. In a case where an account is used across a large number of devices, and the number of tokens acquired reaches a limit, an e-mail transmission failure is more likely to occur. For such a case, the user may be allowed to set a second account and additional accounts with respect to the multifunction peripheral 10, and use the accounts in rotation for e-mail transmission, so that the occurrence of transmission errors can be reduced.

The present disclosure is applicable not only to OAuth authentication methods but also to other token-based authentication methods such as Grant Negotiation and Authorization Protocol (GNAP). The present disclosure is not limited to the embodiments described above, and various modifications may be made thereto. That is, the technical scope of the present disclosure also includes embodiments that may be obtained by combining technical measures that are modified as appropriate without departing from the gist of the present disclosure.

Although some parts of the above-described embodiments are separately described for convenience of explanation, it is needless to say that the embodiments may be combined and implemented within a technically allowable range.

The program(s) that operates on each device (apparatus) in the foregoing embodiments is a program that controls the CPU or the like (program that causes a computer to function) so as to implement the functions according to the foregoing embodiments. Information that is handled by each device (apparatus) is temporarily accumulated in a temporary storage device (for example, RAM) during processing, is then stored in various storage devices such as read only memory (ROM) and an HDD, and is read, corrected, and written by the CPU as needed.

A recording medium that stores the program as referred to herein may be, for example, any of a semiconductor medium (for example, ROM and a non-volatile memory card), an optical recording medium/magneto-optical recording medium (for example, Digital Versatile Disc (DVD)), a Magneto Optical Disc (MO), a Mini Disc (MD), a Compact Disc (CD), and a Blu-ray (registered trademark) Disc (BD), and a magnetic recording medium (for example, a magnetic tape and a flexible disk). Furthermore, not only are the functions of the foregoing embodiments implemented through execution of the loaded program, but the functions of the present disclosure may also be implemented through processing performed in cooperation with, for example, an operating system or other application programs based on instructions of the program.

For market distribution, the program may be stored and distributed in a portable recording medium or transferred to a server computer connected via a network such as the Internet. In this case, a storage device of the server computer is obviously included in the present disclosure.

Furthermore, the functional blocks or various features of the device/apparatus used in the embodiments described above may be implemented or executed as an electrical circuit, such an integrated circuit or a plurality of integrated circuits. An electrical circuit designed to implement the functions described herein may include a general-purpose processor, a digital signal processor (DSP), an application-specific integrated circuit (ASIC), a field programmable gate array (FPGA), or other programmable logic devices, discrete gates or transistor logic, discrete hardware components, or a combination of these. The general-purpose processor may be a microprocessor or a conventional processor, controller, microcontroller, or state machine. The electrical circuit described above may be configured by a digital circuit or an analog circuit. Moreover, when an integrated circuit technology that replaces the current integrated circuits emerges as a result of advances in semiconductor technology, one or more aspects of the present disclosure may also use the new integrated circuits based on such technology.

What is claimed is:

1. An image processing apparatus comprising:
a storage that stores an account for a service providing device; and
one or more controllers that control authentication processing for the service providing device based on the account, wherein
upon receiving input of a new account, the one or more controller store the new account in the storage as a second account if the one or more controllers determine that the new account is compatible with the same authentication method as a first account stored in the storage, the second account being an alternative account to the first account.

2. The image processing apparatus according to claim 1, wherein the one or more controllers execute the authentication processing for the service providing device using the second account if the authentication processing using the first account is inexecutable.

3. The image processing apparatus according to claim 2, wherein the authentication processing includes verifying refresh validity of authorization information for accessing a service provided by the service providing device based on refresh request information associated with the first account, and the refresh request information has an expiration period.

4. The image processing apparatus according to claim 3, wherein the one or more controllers execute the authentication processing for the service providing device using the refresh request information for the second account only if the refresh request information for the first account has expired.

5. The image processing apparatus according to claim 2, wherein the one or more controllers make a notification prompting an owner of the first account to execute reauthentication processing with respect to the first account.

6. The image processing apparatus according to claim 5, wherein the one or more controllers restrict the authentication processing for the service providing device using the second account to when the one or more controllers make a notification prompting reauthentication processing with respect to the first account.

7. The image processing apparatus according to claim 1, wherein the one or more controllers store the new account in the storage as the second account if the new account is for a different service providing device than the first account.

8. The image processing apparatus according to claim 3, wherein the one or more controllers check the expiration period of the refresh request information and makes a notification prompting an owner of the first account or an owner of the second account to refresh the authorization information before the expiration period expires.

9. An authentication processing method comprising:
storing, in a storage, an account for a service providing device as a first account;
storing, upon receiving input of a new account, the new account in the storage as a second account if the new account is determined to be compatible with the same authentication method as the first account, the second account being an alternative account to the first account; and
executing authentication processing for the service providing device based on any of the accounts stored in the storage.
